(19) United States
(12) Patent Application Publication
(10) Pub. No.: US 2020/0311841 A1
(43) Pub. Date: Oct. 1, 2020

(54) SYSTEM AND METHOD FOR QUICK CONTRACT AUTHORING

(71) Applicant: Verdantis Technologies Pvt. Ltd., Mumbai (IN)

(72) Inventors: Soumyarup Dasgupta, Mumbai (IN); Digesh Panchal, Mumbai (IN)

(73) Assignee: Verdantis Technologies Pvt. Ltd., Mumbai (IN)

(21) Appl. No.: 16/587,016

(22) Filed: Sep. 29, 2019

(30) Foreign Application Priority Data
Mar. 28, 2019 (IN) 201921012223

(51) Int. Cl. G06Q 50/18; G06Q 10/10

(52) U.S. Cl. CPC G06Q 50/188; G06Q 10/107

(57) ABSTRACT

A system and method for quick contract authoring is described. The computer implemented system provides integration of contract authoring system and web email application for easy contract authoring without switching from one application into another application. Quick authoring of contract through email web application automatically triggers the workflow, send contract for review, searches contract templates and sends notification on emails. The contract type-subtype has to be selected by the user, and contract related questions have to be answered on the request form. Based on the information entered, the contract request is generated and the system automatically figures out whom this request is to be sent to for further processing. Then, the email address of the next person to whom this contract will be sent is added. A recommended subject and mail body is suggested to the user and the draft of the contract created is also attached.

### CROSS-REFERENCE TO RELATED APPLICATION

The instant application claims priority to Indian Patent Application Serial No. 201921012223, filed Mar. 28, 2019, pending, the entire specification of which is expressly incorporated herein by reference.

### FIELD OF THE INVENTION

The present invention relates to a system and method for quick contract authoring for commercial transactions.

### BACKGROUND OF THE INVENTION

Authoring complex contracts is a very involved process requiring significant investment of time and resources. Businesses need to draft many different types of contracts to run the business. For example, some contracts are authored for sales to customers, including one-time sales and long term agreements that govern discounts or volume commitments. Other examples of contracts include purchasing agreements, marketing or non-disclosure agreements, rental agreements, service contracts, etc. These different types of contracts all require different information in order to author the contract. In the case of a sales agreement, a drafter of the contract would need to know the products and discounts that have been agreed upon. In a service contract, a drafter of the contract may need to include the conditions of coverage. In all cases, it is important for a business to be able to ensure that the contractual terms and conditions are consistent with corporate standards and will protect the company from undue risk. In addition, it is important to be able to produce contracts quickly, while still ensuring that the contract is accurate and per standards. In a sales cycle, a quick turn around on the contract document may make a big difference in closing the deal.

Even with known automated tools, contract authoring can be a very tedious process for multiple reasons. For one, information that needs to be captured to author a contract includes terms that are specific to the type of contract being authored. A sales contract requires different terms than a marketing agreement. For example, for a sales contract, this information may include the products and prices being negotiated, ship to and bill to locations, revenue recognition rules, etc. Each type of contract may have different information that defines the terms of that type of contract.

Further, the type of business terms that needs to be captured varies widely by industry. For example, a company selling project based work would negotiate a completely different set of information than a company selling simple widgets. As a result, known automated tools are generally focused on a specific type of contract and can only automate a small subset of the required functionality, and known products that attempt to automate the entire lifecycle of a contract (i.e., creation of a contract and execution of a contract) tend to be specialized for a specific industry. Therefore, any generic contract authoring solution that can handle all types of contracts becomes complex and unwieldy for a typical user when authoring contracts because the user interface cannot be tailored for a specific type of contract or industry or user role.

Because of these problems, many users continue to use custom spreadsheets or word processing documents to enter the initial contract quickly, and later transfer that information into a contracts application via data re-entry or custom import/integration. However, this can lead to costly human errors.

### OBJECTS OF THE INVENTION

The object of the present invention is to provide a user friendly system to save time and perform contract authoring activities with ease.

Another object of the present invention is to provide a system and a method which integrates the contract authoring system and web email application for easy contract authoring without switching from one application into another application.

### SUMMARY OF THE INVENTION

Before the present invention is described, it is to be understood that the present invention is not limited to specific methodologies and materials described, as these may vary as per the person skilled in the art. It is also to be understood that the terminology used in the description is for the purpose of describing the particular embodiments only and is not intended to limit the scope of the present invention.

The present invention describes a quick one touch Contract authoring system through integrated email web platform. The invention provides integration of contract authoring system and web email application for easy contract authoring without switching from one application into another application. Quick authoring of contract through email web application automatically triggers the workflow, send contract for review, searches contract templates and sends notification on emails. The contract type-subtype has to be selected, and contract related questions have to be answered on the request form. Based on the information entered, the contract request is generated and the system automatically figures out whom this request is to be sent to for further processing.

### DETAILED DESCRIPTION OF THE INVENTION

The present invention describes a user friendly system and method for contract authoring activities. The system is an integration of a web email system and a contract management system which enables user to save time and perform contract authoring activities with ease. The user while using his email inbox, from his email inbox can also use certain features of contract management system and accordingly can send contracts into contract management system for review. The user while staying on his email inbox can select templates from contract management system without actually logging into the system.

The given embodiment of the present invention emphasises on quick one touch contract authoring through integrated email web platform. The invention provides integration of contract authoring system and web email application for easy contract authoring without switching from one application into another application.

The computer implemented system of quick authoring of contract through email web application automatically triggers the workflow, sends contract for review, searches contract templates and sends notification on emails. Certain restriction rules are however applied in the system such as the user cannot raise requisition for contract value higher than a certain amount or the user cannot author contract for certain restricted categories, etc. For example a user may have authority to raise contract requisition up to a certain value and not beyond that, further the user cannot raise requisition for certain categories like procuring medicines within organization. The system of the present invention runs on a multi tenant setup. Each user is allotted a specific tenant to use the system. One user cannot see the setup of another user's tenant. A particular tenant/user logs in to the system using his/her credentials. One needs to be a valid user to use this system.

In an embodiment of the present invention, the user selects the option to request new contract. This opens a blank draft of email with a panel on the left, where the contract request wizard appears. This guides the user through a simple three step process to place a request for a contract.

The first step of this method is to select the contract type and subtype. Contract types and subtypes are configurable. For example, vendor contract or customer contract are types of contracts then the subtypes are based on nature of transactions-goods or services, and for services, whether it is maintenance service or hotel service or consultancy service.

Once contract type-subtype has been selected, more contracts related questions come up on the request form. The system may ask a list of questions. For example the type of consultancy agreement required. The user enters his response as tax consultant. The system then asks to choose the jurisdiction. To which the user gives his response. According to the responses inputted by the user, the system suggests the contract template. These questions are dependent on the answers to the previous ones, that is, answer to one question decides what would be the next set of information which the user needs to fill in to place the contract request. The system hence is intuitive and dynamic.

Once the user has filled all the mandatory fields, the contract request is generated. The system automatically figures out whom this request is to be sent to for further processing. There is preconfigured workflow—which maps the user. For example if A is the contract creator or author, then A will remain pre-mapped to B for further process and approval of the contract The complex set of rules configured within the system is triggered directly from within the system ensuring that the correct workflow for that contract is followed.

The system also smartly conveys this information to the designated user via the system's primary function—email. The moment a contract request is placed, the draft mail on the right hand side gets populated with the email address of the next person to whom this contract will be sent. There is already a stored database of email address and their hierarchical position with the system. A recommended subject and mail body is also suggested to the requester, further reducing his effort. The initial draft of the contract created is also attached to this mail. Initial draft of email is user configurable and can be edited. The initial draft contains general communication that so and so contract is being provided for review, and may contain some basic details about contract type and subtype.

All the user now needs to do is send the contract and the contract is on its way for further processing and approvals. The contract is further edited during the process of approval. For the user, he neither needs to log onto a foreign application nor does he need to remember whom to get in touch with for this contract. The present invention therefore provides a user friendly system to save time and perform contract authoring activities with ease.

In some applications, the present invention described above may be provided as elements of an integrated software system, in which the features may be provided as separate elements of a computer program. Some embodiments may be implemented, for example, using a computer-readable storage medium (e.g., non-transitory) or article which may store an instruction or a set of instructions that, if executed by a processor, may cause the processor to perform a method in accordance with the embodiments. Other applications of the present invention may be embodied as a hybrid system of dedicated hardware and software components. Moreover, not all of the features described above need be provided or need be provided as separate units. Additionally, it is noted that the arrangement of the features do not necessarily imply a particular order or sequence of events, nor are they intended to exclude other possibilities. For example, the features may occur in any order or substantially simultaneously with each other. Such implementation details are immaterial to the operation of the present invention unless otherwise noted above.

The exemplary methods and computer program instructions may be embodied on a computer readable storage medium (e.g., non-transitory) that may include any medium that can store information. Examples of a computer readable storage medium (e.g., non-transitory) include electronic circuits, semiconductor memory devices, ROM, flash memory, erasable ROM (EROM), floppy diskette, CD-ROM, optical disk, hard disk, fiber optic medium, or any electromagnetic or optical storage device. In addition, a server or database server may include computer readable media configured to store executable program instructions. The features of the embodiments of the present invention may be implemented in hardware, software, firmware, or a combination thereof and utilized in systems, subsystems, components or subcomponents thereof.

Furthermore, a software program embodying the features of the present invention may be used in conjunction with a computer device or system. Examples of a computing device or system may include, but are not limited to, an electronic book reading device, a computer workstation, a terminal computer, a server computer, a handheld or mobile device (e.g., a tablet computer, a personal digital assistant “PDA”, a mobile telephone, a Smartphone, etc.), a web appliance, a network router, a network switch, a network bridge, any machine capable of executing a sequence of instructions that specify an action to be taken by that machine, and any combinations thereof. In one example, a computing device may include and/or be included in, a kiosk.

As used herein, the term “mobile device” is intended to encompass any form of programmable computing device as may exist, or will be developed in the future, that implements a communication module for wireless voice and data communications, including, for example, cellular telephones, personal data assistants (PDA's), palm-top computers, laptop, and notebook computers, wireless electronic mail receivers (e.g., the BLACKBERRY and TREO devices), multimedia Internet enabled cellular telephones (e.g., the BLACKBERRY STORM, and similar personal electronic devices that include a wireless communication module, processor and memory.

The computer device or system may also include an input device. In one example, a user of the computer device or system may enter commands and/or other information into computer device or system via an input device. Examples of an input device may include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touchscreen, and any combinations thereof. The input device may be interfaced to bus via any of a variety of interfaces including, but not limited to, a serial interface, a parallel interface, a game port, a USB interface, a FIREWIRE interface, a direct interface to bus, and any combinations thereof. The input device may include a touch screen interface that may be a part of or separate from the display.

A user may also input commands and/or other information to the computer device or system via a storage device (e.g., a removable disk drive, a flash drive, etc.) and/or a network interface device. A network interface device, such as network interface device may be utilized for connecting the computer device or system to one or more of a variety of networks and/or one or more remote devices connected thereto. Examples of a network interface device may include, but are not limited to, a network interface card (e.g., a mobile network interface card, a LAN card), a modem, and any combination thereof. Examples of a network may include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software, etc.) may be communicated to and/or from the computer device or system via a network interface device.

The computer device or system may further include a video display adapter for communicating a displayable image to a display device, such as a display device. Examples of a display device may include, but are not limited to, a liquid crystal display (LCD), a cathode ray tube (CRT), a plasma display, a light emitting diode (LED) display, and any combinations thereof. In addition to a display device, the computer device or system may include one or more other peripheral output devices including, but not limited to, an audio speaker, a printer, and any combinations thereof. Such peripheral output devices may be connected to a bus via a peripheral interface. Examples of a peripheral interface may include, but are not limited to, a serial port, a USB connection, a FIREWIRE connection, a parallel connection, and any combinations thereof.

The disclosure has been described with reference to the accompanying embodiments which do not limit the scope and ambit of the disclosure. The description provided is purely by way of example and illustration.

The embodiments herein above and the various features and advantageous details thereof are explained with reference to the non-limiting embodiments in the following description. Descriptions of well-known components and processing techniques are omitted to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments so fully revealed the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for description and not of limitation. Therefore, while the embodiments herein have been described in terms of preferred embodiments, those skilled in the art will recognize that the embodiments herein can be practiced with modification within the spirit and scope of the embodiments as described herein.

Throughout this specification, the word “comprise,” or variations such as “comprises” or “comprising,” will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the disclosure to achieve one or more of the desired objects or results.

Any discussion of files, acts, materials, devices, articles or the like that has been included in this specification is solely for providing a context for the disclosure. It is not to be taken as an admission that any or all of these matters form a part of the prior art base or were common general knowledge in the field relevant to the disclosure as it existed anywhere before the priority date of this application.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

What is claimed is:

1. A computer-implemented method for quick authoring a contract with an integrated email application and at least one of a plurality of restriction rules, comprising the steps of:
selecting a request option available on the email application to request a new contract by a user;
selecting on the email application a contract type and subtype from among a plurality of contract templates;
evaluating the selected contract type and subtype template from a template evaluation option available on the email application and formatting a series of questions requiring a response by the user;
receiving a user response on the email application to at least one of the plurality of questions;
generating on the email application a customized contract request based upon the selected contract type and subtype template depending on the evaluation step and received user responses;
sending the generated contract request through the email application to a predetermined list of users for further processing and approval of the contract; and
integrating the generation of the contract request with a generation of a corresponding email draft along with a recipients' email addresses.

2. The method as claimed in claim 1, wherein the restriction rules are at least one selected from restriction over a contract value and restriction over authorizing a contract in certain categories.

3. The method as claimed in claim 1, wherein the contract type is at least one selected from vendor contract and customer contract on the email application.

4. The method as claimed in claim 1, wherein the contract subtype is at least one selected from goods, maintenance service, hotel service and consultancy service on the email application.

5. The method as claimed in claim 1, wherein the questions are dependent on the user responses to a previous set of questions.

6. The method as claimed in claim 1, wherein the correct predetermined workflow of the contract is triggered by a complex set of rules configured within the system on the email application.

7. The method as claimed in claim 1, wherein the system consists of a stored database of email addresses and their hierarchical positions within the system.

8. The method as claimed in claim 1, wherein the system recommends a subject and mail body of the email to the user with an attached initial draft of the generated contract.

9. The method as claimed in claim 7, wherein the draft of the email is user configurable and open for editing.
